(19) United States
(12) Patent Application Publication
(10) Pub. No.: US 2008/0320110 A1
(43) Pub. Date: Dec. 25, 2008

(54) FIRMWARE ROLLBACK AND CONFIGURATION RESTORATION FOR ELECTRONIC DEVICES

(75) Inventor: Rabindra Pathak, Vancouver, WA (US)

Correspondence Address: LAW OFFICES OF LARRY K. ROBERTS, INC., 2 PARK PLAZA, SUITE 300, IRVINE, CA, 92614, US

(73) Assignee: Sharp Laboratories of America, Inc.

(21) Appl. No.: 11/768,132

(22) Filed: Jun. 25, 2007

(51) Int. Cl. G06F 15/177; G06F 9/44

(52) U.S. Cl. 709/220; 717/173

(57) ABSTRACT

Techniques are described for managing one or more electronic devices connected on a network. A central management system may be configured to control firmware rollback activity for the devices. The central management system may in some embodiments also rollback configuration settings. In another embodiment, a central management system may perform device cloning activities.

### BACKGROUND

Customers frequently need to upgrade the firmware of devices, such as, for example, multifunction printing (MFP) devices, in order to fix bugs, add features and to generally improve the product. However, firmware upgrade can sometimes create bigger problems than it solves. There is a possibility that firmware upgrade would fail in the middle of the upgrade. It is also possible that firmware may have defects or it may have features undesirable to the customer. In some cases, firmware upgrade failure may result in wiping out or corrupting the device configuration settings.

Most of the current restoration techniques provide storage on the device itself to backup the old version of firmware and restore the firmware from device local storage. None of these techniques provide the facility to restore configuration as part of firmware rollback.

### SUMMARY OF THE DISCLOSURE

Techniques are described for managing one or more electronic devices connected on a network. A central management system may be configured to control firmware rollback activity for the devices. The central management system may in some embodiments also rollback configuration settings. In another embodiment, a central management system may perform device cloning activities.

### BRIEF DESCRIPTION OF THE DRAWINGS

Features and advantages of the disclosure will readily be appreciated by persons skilled in the art from the following detailed description when read in conjunction with the drawing wherein:

FIG. 1 diagrammatically depicts an exemplary operating environment which may be used for managing firmware for devices.

FIG. 2 depicts a flow diagram of an exemplary operational flow diagram for a central management system for controlling firmware updating, rollback and cloning functions for a networked device or group of devices.

FIG. 3 depicts a flow diagram of an exemplary algorithm for storing the current firmware and device settings for the firmware rollback.

FIG. 4 depicts a flow diagram of an exemplary algorithm for initiating a firmware rollback.

FIG. 5 depicts a flow diagram of an exemplary algorithm for cloning the firmware and configuration settings of a device.

FIG. 6 illustrates a flow diagram of an exemplary embodiment of an algorithm which may be executed to clone a newly installed device.

### DETAILED DESCRIPTION

In the following detailed description and in the several figures of the drawing, like elements are identified with like reference numerals. The figures are not to scale, and relative feature sizes may be exaggerated for illustrative purposes.

An exemplary embodiment of a technique is described for rolling back firmware for one or more networked devices, e.g. MFPs, and restoring their configurations if required. Firmware rollback along with firmware upgrade is controlled and driven by a central management system. The central management system maintains a local repository of firmware. It may also maintain a database of current firmware on each MFP and its current configuration data. When a firmware upgrade is initiated from the central management system, the central management system monitors the firmware upgrade status. If the firmware upgrade fails, then the central management system may attempt to rollback the firmware to its old version. Some devices can do the rollback by themselves; in that case the central management system may allow the device to carry on the rollback. The central management system may also restore the configuration if needed. The user may request the central management system to rollback the firmware for the device, e.g., a MFP, anytime after the firmware is properly upgraded.

An exemplary embodiment may include one or more of the following features:
Firmware rollback and configuration restoration is managed by the central management system, unlike existing techniques in which these activities are managed by the individual devices themselves.
Copies of existing firmware and configurations for each device, e.g. an MFP, are stored by the central management system.
Configuration restoration of the device may also be performed under control of the central management system.
A firmware repository of the central management system may be utilized to enhance the speed of firmware rollback. For example, for all the MFPs for whom the firmware was installed using the central management system, there would be already a copy of the firmware in the firmware repository of the central management system, and so the central management system does not have to make a copy of that firmware. This will greatly reduce the time taken to prepare for and rollback the firmware.
A facility may be provided by which firmware can be rolled back either for one device or a group of devices.
Firmware rollback combined with configuration restoration can provide a complete device cloning whereby a device can be “fully backed up” and a new device can be cloned with same firmware and settings.

In an exemplary embodiment, a printer administration utility (PAU) or a management gateway may serve as a central management system for managing firmware for MFP devices connected on a network. For example, a PAU may be configured to access and initiate the firmware upgrade for MFP devices in the network. The PAU maintains a local firmware repository to store the firmware for upgrade. The PAU also maintains the storage for the current firmware (or information about how to get the current firmware) for each MFP. Along with firmware information it also stores the configuration information about each MFP.

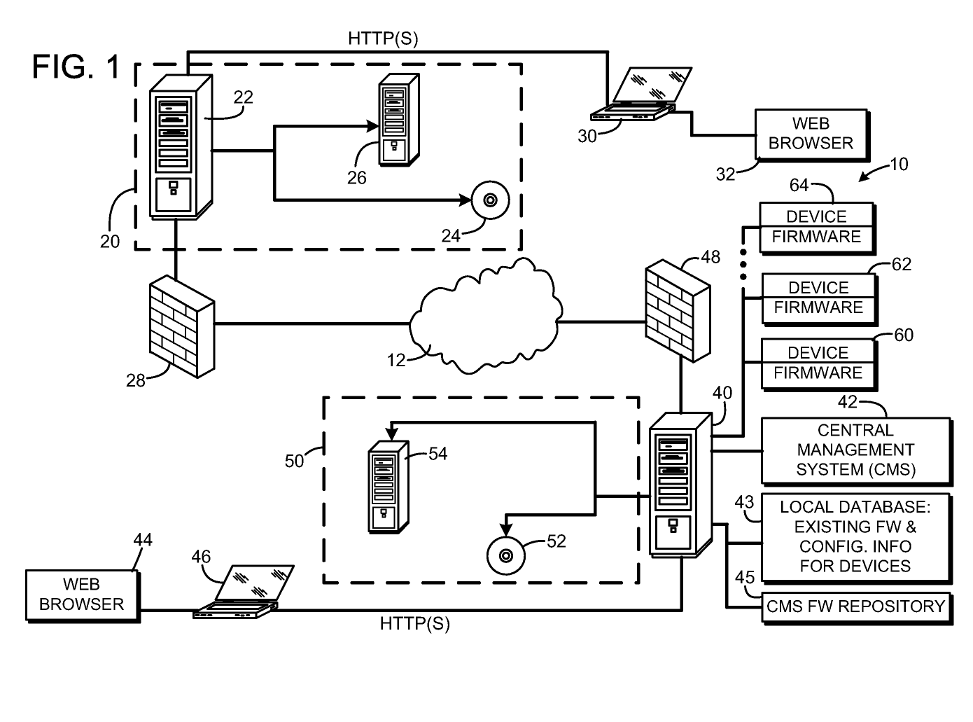

FIG. 1 diagrammatically depicts an exemplary operating environment which may be used for managing the firmware for devices such as MFPs connected on a network. In this embodiment, new or updated firmware for a device or set of devices may be made available through a firmware repository 20 hosted on a web server 22. Users with proper privileges may access, e.g. to manage or browse, this web repository through an HTTP or HTTPS connection via a web browser 32, which may be running, by way of example, on a terminal 30, or via the Internet 12, which may be connected through a firewall 28 to web server 22. Authorized persons may publish new firmware and remove or update existing firmware. The firmware may be obtained from a CD 24 using a CD drive, or from a network storage drive 26, or from another firmware repository.

Customers/users and dealers with required access privileges may access this web repository 20 through a web browser to obtain firmware for a machine. In some applications, access privileges may not be required, so that the firmware update access is freely available to customers/users.

A central management system (CMS) 42 for a network of devices 60, 62 . . . 64 may be implemented as a software application such as a management gateway or PAU, e.g., running on a console, terminal or server 40 located on a customer's intranet, for example. The terminal or server 40 typically includes a processor, a volatile memory or RAM, and a nonvolatile memory (e.g., ROM, hard drive, CD-ROM). The nonvolatile memory generally provides storage of computer/processor-readable instructions, data structures, program modules and other data for the terminal or server 40, which may be executable on the terminal or server 40. The CMS 42 may be implemented as a processor-readable medium, e.g. an electronically accessible memory, including processor-executable instructions configured for centrally managing the networked group of electronic devices 60, 62, 64, as described more fully below.

In an exemplary embodiment, the terminal 40 is connected on the intranet behind a firewall 48 through which a connection to the Internet 12 is made. A management gateway application and techniques for remote firmware management are described in pending application Ser. No. 11/670,875, entitled “Remote Firmware Management for Electronic Devices,” filed Feb. 2, 2007, the entire contents of which are incorporated herein by this reference. A PAU from Sharp Electronics, for example, is a networked printer management tool using standard Simple Network Management Protocol (SNMP) to monitor status and enable remote configuration of networked digital printer and copier devices. This exemplary PAU may be utilized by network administrators for monitoring all Sharp network connected printers and copiers. The utility keeps a constant status check on the devices, warning when some action is necessary by the administrator, for example if paper supply is low, or toner supply is low, or if a periodical service is due, and alerting when a problem has occurred, for example paper jam or toner exhausted. By utilizing the PAU, network administrators can manage all digital printers and copiers remotely via the network from a single console.

A local firmware repository 50 may be connected on the intranet. The repository 50 may include a local CD drive 52 and a network drive 54. The repository 50 may be accessed and maintained by the CMS 42.

The CMS may also maintain a database 43 for storing data such as configuration data for each of the devices 60, 62, 64, and a CMS firmware repository 45. The CMS repository 45 may be implemented as a network drive on server 40, for example, or as a separate server or network drive.

Some applications may not employ a remote firmware repository such as repository 20. Further some applications may not employ a repository 20 or a repository 50, and instead use just a CMS repository 45 in which firmware updates and images are stored. In other embodiments, local repository 50 and CMS firmware repository 45 may be omitted, and firmware updates and images stored only remotely, e.g. on a remote firmware repository 20.

Users of the CMS 42 can access the local repository 50 to add new firmware and update existing firmware. In the example illustrated in FIG. 1, users of a PAU implemented as system 42 can obtain new firmware from a local CD drive 52, a network drive 54 and from the web firmware repository 20, in order to update or install firmware on devices 60, 62, 64. The devices 60, 62, 64 may be multifunction printer (MFP) devices, for example. Thus PAU users will be able to add new firmware to the local repository 50 from a web firmware repository 20 by using a web browser, e.g. a web browser 44 running on a local terminal 46. In an exemplary embodiment, the terminal 46 may be connected to the console 40 through an HTTPS or HTTP connection. Users of system 42 may also be able to access stored versions of firmware saved on CMS repository 45 as well as configuration settings stored in CMS database 43 for the devices 60, 62, 64. For some applications, the CMS database 43 and the CMS firmware repository 45 may be combined on the same electronic memory, such as a network hard drive. For other application, the database 43 and repository 45 may be on separate, local (to the CMS) electronic memory devices. For example, there may be an existing legacy database which the CMS may continue to maintain separately. Also, if firmware for electronic device marketed by different manufacturers are maintained, separate databases or repositories may be maintained, so that firmware for devices from the same manufacturer are maintained in the repository 45, and firmware for devices for a different manufacturer are maintained in a database 43.

The firmware repositories 50 and 45 local to the CMS 42 and the web firmware repository 20 are independent of each other, though they use the same technology to store, locate and retrieve the firmware.

A manufacturer may release new firmware on CDs, accessed through a CD drive such as CD drive 52. In an exemplary embodiment, the system 42 will be able to understand the structure of the CD repository. There may also be situations in which a CD may contain the firmware without any also being on a local firmware repository.

In an exemplary embodiment, the CMS 42 is adapted to manage firmware for devices 60, 62, 64 such as MFPs. The CMS 42 may be configured to access and initiate firmware upgrades for MFP devices 60, 62, 64 in the network. The CMS maintains the local firmware repository 50 to store the firmware for upgrade. The CMS may also maintain the storage for the current firmware (or information about how to get the current firmware) for each MFP. Along with firmware information it may also store the configuration information about each MFP in local database 43. Thus, existing firmware and configuration information may be stored in database 43, for the devices 60, 62 and 64 in this exemplary embodiment. Configuration information may include, for example, the contents of the MFP address book, facsimile numbers, and the like.

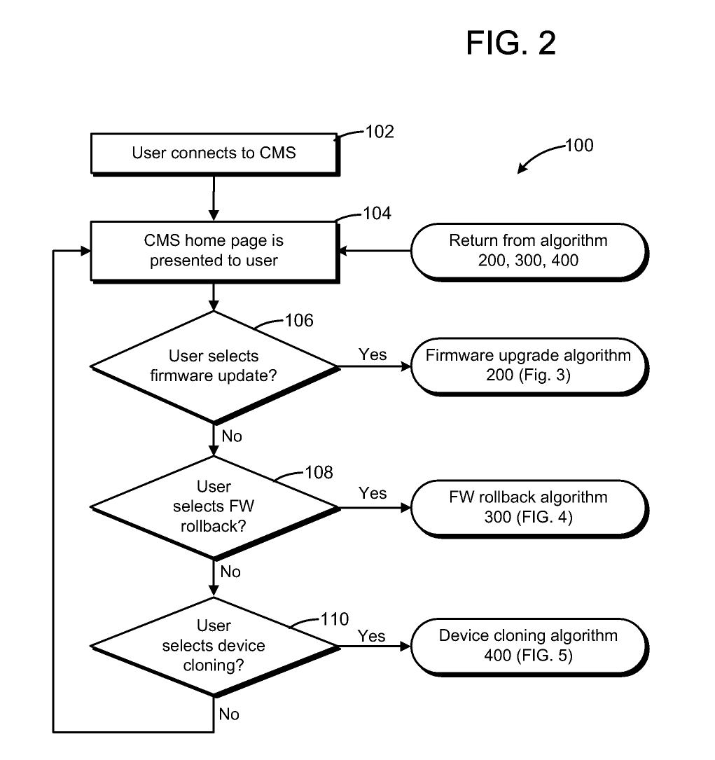

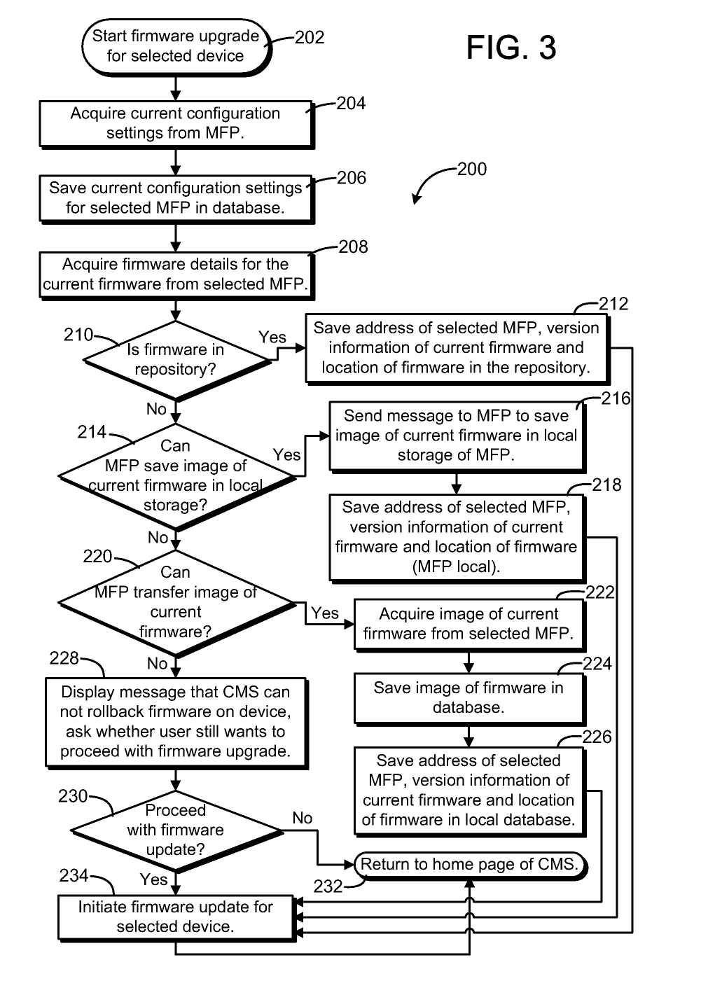

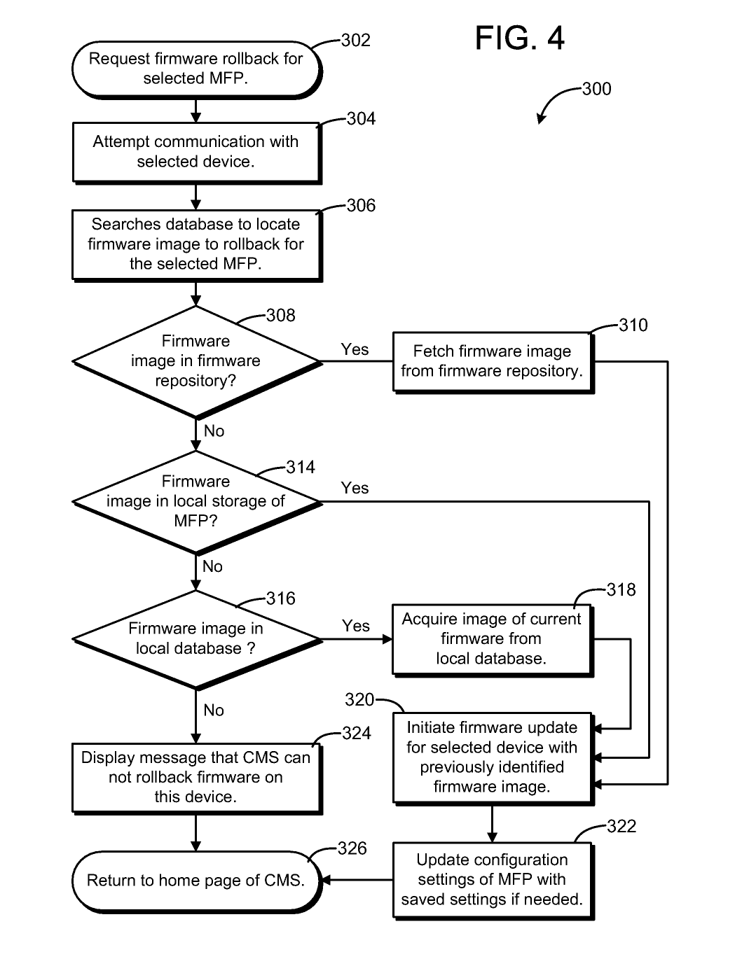

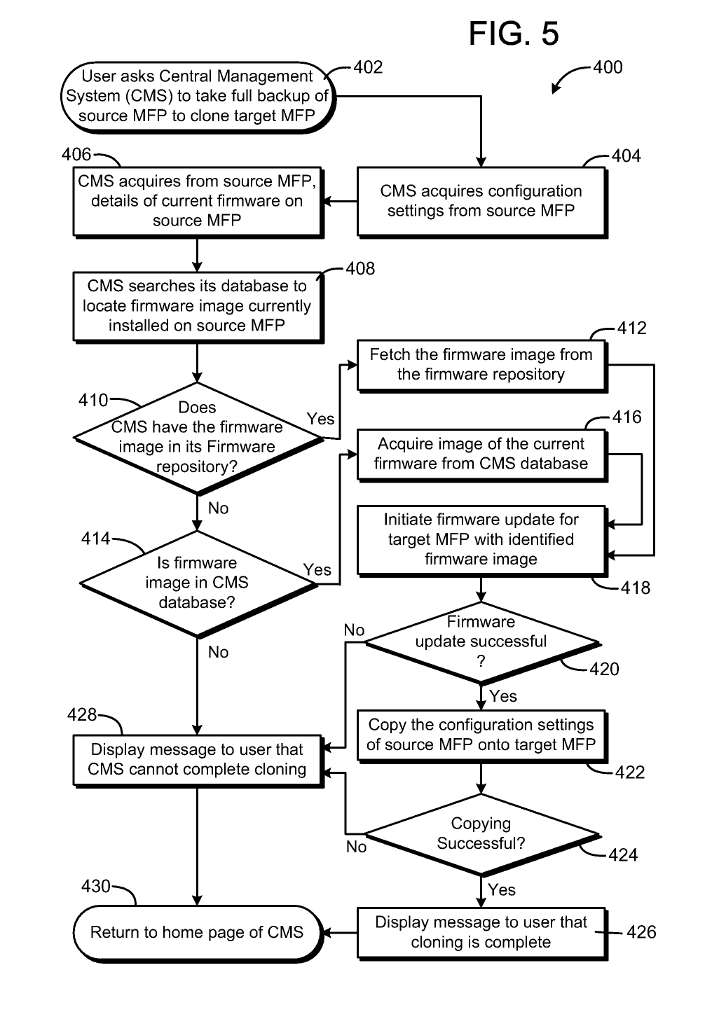

FIG. 2 illustrates a simplified flow diagram of an algorithm 100 performed by a CMS such as CMS 42. At 102, a user connects to the CMS, e.g. using terminal 46 or a remote terminal such as terminal 32, and the CMS home page is presented to the user at 104. The user may navigate through a menu, which includes, for example, the function selection steps 106, 108, 110. Step 106 determines whether the user has selected the firmware update function. If so, operation proceeds to algorithm 200 illustrated in FIG. 3. Step 108 determines whether the user has selected a firmware rollback function. If so, operation proceeds to the algorithm 300 illustrated in FIG. 4. Step 110 determines whether the user has selected a device cloning function. If so, operation proceeds to the algorithm 400 illustrated in FIG. 5. Of course, it will be appreciated that the CMS 42 may and typically will perform other functions not illustrates explicitly in FIG. 2.

FIG. 3 illustrates a flow diagram of an exemplary embodiment of an algorithm carried out by the CMS 42 for initiating a firmware update for a networked device 60, 62 or 64. The algorithm includes storing the current firmware and device settings for a firmware rollback, if that is needed or desired later. Preparation for a firmware rollback starts when a firmware upgrade is initiated, e.g., by the user requesting the CMS 42 to start a firmware upgrade for a selected device, at step 202. After the user selects a device, e.g. one of MFPs 60, 62, 64, then the system 42 displays a list of compatible firmware from a repository such as repository 45, repository 50 or even remote repository 20. The user selects the desired firmware and instructs the CMS 42 to upgrade the selected firmware. At 204, the CMS 42 acquires the current configuration settings from the selected MFP. To accomplish this, the CMS 42 may send a request to the selected MFP to provide all the current configuration settings. At 206, the CMS saves these settings in its database 43.

At 208, the CMS 42 acquires the details of the current firmware on the selected MFP from the MFP. This may be done by the CMS sending a request to the selected MFP to provide the details of the current firmware on the MFP, such as the firmware version number, etc. At 210 the CMS determines whether it already has the current version of firmware in its repository. If yes, then at 212 the CMS saves just the version and location information about the current firmware of the selected MFP, and operation then branches to 234 to initiate the firmware update for the selected device. If at 210, the current firmware is not stored in the repository, then at 214 the CMS determines whether the selected MFP is capable of saving an image, i.e. a copy, of the current firmware. This may be accomplished by asking the device if it is capable of saving the copy of the firmware in the MFP's local storage. If the MFP can save the firmware image, at 216, the CMS sends a message to the MFP instructing the MFP to save the image of the firmware in the MFP's local storage. At 218, the address of the selected MFP, the version information of its current firmware and the location of the firmware at the MFP local storage is saved. Operation then branches to 234 to initiate the firmware update.

If at 214, the MFP can not save the firmware, then at 220, the CMS checks whether the MFP can transfer an image of the current firmware to the CMS. If MFP cannot do so then at 228, a message or warning to the user that the selected MFP does not have a rollback capability, and at 230, the user can make a decision to proceed with firmware update or not. If the MFP can send the firmware image to the management system, the CMS will save the image in its database 43. Thus, an image of the current version of the firmware is acquired from the selected MFP at 222, and is saved in the database at 224. At 226, the address of the selected MFP, the version information of the current firmware and the location of the firmware in the database 43 are saved at 226. Operation then proceeds to step 234 to initiate a firmware update for the selected devices. and proceed with the firmware upgrade.

If the firmware upgrade fails for some reason, then the management system 42 will do retries, and if retries also fail, then it will send a notification to the user.

FIG. 4 depicts a flow diagram of an exemplary algorithm 300 for initiating a firmware rollback. At 302, if the user is logged into the CMS 42, then the user will ask the system 42 to rollback the firmware to the selected device 60, 62 or 64. At 302, the CMS 42 will attempt to communicate with the device to determine if the device is responding. There are cases in which the device may be non-responsive due to firmware update failures; but in most cases the device will respond to the management system 42 even if the firmware update has failed.

At 306, the CMS 42 checks its database 43 to determine the location of the image of the old firmware. In an exemplary embodiment, the image of the old firmware will be in one of the three places, a firmware repository such as repository 50 or repository 20 (step 308), on the local storage of the MFP device (step 314) or in the local database 43 (step 316). The CMS locates and fetches the firmware image in the case of respective step 310 or step 318, and initiates a firmware upgrade for the MFP (step 320). In the case in which the firmware image is stored in local storage on the selected MFP, the management system 42 instructs the MFP to restore to the firmware image stored on the MFP's local storage. After the old firmware image is restored to the MFP, the CMS then checks the settings of the device. If settings were corrupted or changed from the last state, then it restores the configuration settings with the local copy of the configuration settings for the MFP (step 322).

If the old firmware image can not be located, then at 324, a message is displayed that the CMS 42 cannot roll back the firmware for the selected device. At 326, operation returns to the home page of the management system.

The CMS 42 may also be employed to clone a networked device such as an MFP. This may be useful, for example, for a case in which a new MFP is installed on the user intranet, and the use desires to set it up with the same settings and firmware as is used on an already installed MFP. Cloning can be used also when a user wants to pull out a non functional MFP from a network and plug in another MFP in its place. In this case, the functional MFP can be a clone of the non-functional MFP. Once the new functional MFP is cloned then the non-functional MFP can be unplugged from the network.

FIG. 5 depicts an exemplary algorithm 400 for an exemplary embodiment of a cloning process. At 402, the user asks the CMS to take a full backup of a source device such as an MFP, to clone a target device, in this example a target MFP. At 404, the CMS 42 acquires the configuration settings from the source MFP, and at 406 the details of the current firmware on the source MFP. At 408, the CMS searches its database 43 in an attempt to locate an image of the firmware currently installed on the source MFP. If at 410, the CMS determines that it has the firmware image in its firmware repository, then at 412 the firmware image is retrieved from the firmware repository. At 418, a firmware update is initiated for the target MFP with the identified firmware image. At 420, the CMS determines whether the firmware update was successful. If not, a message is displayed at 428 that the CMS cannot complete the cloning. If yes, at 422, the configuration settings of the source MFP are copied onto the target MFP. At 424, the CMS determines whether the copying was successful. If so, a message is displayed at 426 that the cloning is complete, and operation returns at 430 to the CMS home page. If the copying was unsuccessful, operation proceeds to 428.

Returning to step 410, if the CMS does not have the firmware image in its repository, the CMS determines at 414 whether the firmware image is in the CMS database 43. If so, operation proceeds to 416, an image of the current firmware is acquired from the database, and operation proceeds to step 418. If the CMS does not have the firmware image in its database at 414, then a message is displayed to the user at 428 that the CMS cannot complete the cloning process, and operation returns to the CMS home page at 430.

Cloning can also be used to setup a new device on the network, e.g. a MFP. Whenever a new MFP is plugged in the network, it may announce its presence which can be detected by the CMS. The user can create a profile in the CMS for each family of devices. The profile may include default settings and a firmware file. The CMS can automatically choose the profile based on which family of devices the new device belongs to and then apply that profile (firmware and settings) to the new device. Thus, new devices can be cloned from a profile set by the user.

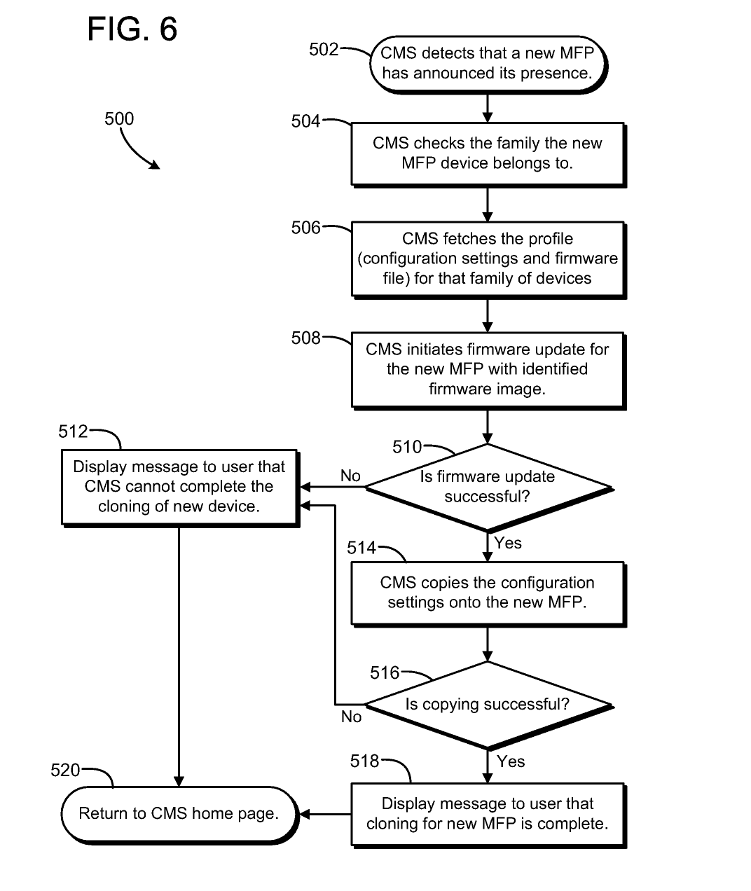

FIG. 6 illustrates a flow diagram of an exemplary embodiment of an algorithm 500 which may be executed using the CMS 42 to clone a newly installed device. At 502, the CMS detects that a new MFP has announced its presence on the network. The CMS checks at 504 the family of devices for the new MFP, and fetches (506) the profile (configuration settings and firmware file) for that family of devices. The profile data may be stored, for example, in the CMS database 43 and/or CMS repository 45. The CMS initiates a firmware update at 508 for the new MFP with the identified firmware image. At 510, the CMS checks to determine whether the firmware update was successful. If not, a message is displayed at 512 that the CMS cannot complete the cloning of the new device, and operation returns to the CMS home page. If the firmware update was successful, the CMS attempts to copy the configuration settings onto the new MFP at 514. If the copying is successful (516), a message is displayed (518) to the user that the cloning for the new MFP is complete, and operation returns to the home page (520). If the copying was not successful, operation branches to 512 to display a message that the cloning cannot be completed.

Although the foregoing has been a description and illustration of specific embodiments of the subject matter, various modifications and changes thereto can be made by persons skilled in the art without departing from the scope and spirit of the invention as defined by the following claims.

What is claimed is:

1. A computer-implemented method for managing firmware updating for a networked group of electronic devices connected on a user intranet, each of the electronic devices including firmware stored on device memory, the method comprising:
providing a central management system configured to control firmware update and firmware rollback activity for said networked group of electronic devices;
maintaining a local electronically accessible memory storage accessible by the central management system for storing firmware images of firmware versions used by one or more of the electronic devices;
accessing the central management system to initiate a firmware rollback to a previous firmware version utilized by a selected one of said electronic devices, using a stored firmware image from said local electronically accessible memory storage.

2. The method of claim 1, wherein said providing said central management system comprises running a software application installed on a terminal or server connected on the user intranet.

3. The method of claim 1, wherein said maintaining said local database further comprises storing configuration settings of said one or more of the electronic devices, and said accessing the central management system to initiate a firmware rollback comprises initiating a configuration rollback to a stored configuration setting for said selected one of said electronic devices.

4. The method of claim 1, wherein said networked group of electronic devices is a networked group of multifunction printing devices.

5. A processor-readable medium comprising processor-executable instructions configured for centrally managing a networked group of electronic devices connected on a user intranet, each of the electronic devices including firmware stored on device memory, the processor-executable instructions further configured for:
controlling firmware update and firmware rollback activity for the networked group of electronic devices;
maintaining a local electronically accessible memory storage for storing firmware images of firmware versions used by one or more of the electronic devices;
initiating a firmware rollback to a previous firmware version utilized by a selected one of said electronic devices, using a stored firmware image from said local electronically accessible memory storage.

6. The processor-readable medium of claim 5, wherein the processor-executable instructions are further configured for:
maintaining a local electronically accessible memory storage for storing configuration settings used by one or more of the electronic devices; and
said initiating a firmware rollback further includes resetting said selected electronic device to said stored configuration settings.

7. A method for managing firmware updating for one or more electronic devices connected on a user intranet, each of the one or more electronic devices including firmware stored on device memory, the method comprising:
maintaining a central management system configured to control firmware update and firmware rollback activity for said one or more electronic devices;
maintaining an electronically accessible firmware repository for storing firmware versions for said one or more electronic devices;
maintaining a local database accessible by the central management system for storing firmware images of current firmware versions in use by one or more of the electronic devices, and configuration settings for one or more of the devices;
accessing the central management system to initiate a firmware update activity for a selected electronic device;
storing an image of the current firmware version and a current set of said configuration settings for said selected device;
conducting a firmware update activity for said selected electronic device;
conducting a firmware rollback to said current firmware version and said current set of configuration settings using said stored image of the current firmware version and the current set of configuration settings.

8. The method of claim 7, wherein said storing said image of the current firmware and said current set of said configuration setting comprises storing said image and said current set in the local database.

9. The method of claim 8, wherein said conducting the firmware rollback including retrieving the image of the current firmware and the current set of configuration settings for the selected device from said local database.

10. The method of claim 7, wherein said storing said image of the current firmware and said current set of said configuration setting comprises storing said image and said current set on a local storage of said selected device.

11. The method of claim 7, wherein said maintaining said central management system comprises running a software application installed on a terminal or server connected on the user intranet.

12. The method of claim 7, wherein the firmware repository includes a firmware repository maintained on a remote server outside the user intranet.

13. The method of claim 7, wherein said maintaining said central management system comprises maintaining said central management system on said intranet behind a firewall.

14. The method of claim 7, wherein said one or more electronic devices includes a networked group of multifunction printing devices.

15. A computer-implemented method for managing firmware updating for one or more electronic devices connected on a user intranet, each of the one or more electronic devices including firmware stored on device memory, the method comprising:
maintaining a central management system connected on the intranet behind a firewall, the central management system configured to control firmware update and firmware rollback activity for said one or more electronic devices;
maintaining an electronically accessible firmware repository for storing firmware updates, including firmware updates for said one or more electronic devices;
maintaining a local database accessible by the central management system for storing firmware images of current firmware in use by one or more of the electronic devices, and configuration settings for one or more of the devices;
accessing the central management system to initiate a firmware update activity for a selected electronic device of said one or more electronic devices;
storing an image of the current firmware and a current set of said configuration settings for said selected device in said local database;
conducting a firmware update activity for said selected electronic device;
monitoring said firmware update activity by the central management system to determine whether the firmware update activity results in a successful firmware update for said selected electronic device; and
if the firmware update is unsuccessful, conducting a firmware rollback to said current firmware and said current set of configuration settings, said conducting the firmware rollback including retrieving the image of the current firmware and the current set of configuration settings for the selected device from said local database.

16. The method of claim 15, wherein said one or more electronic devices includes one or more multifunction printing (MFP) devices.

17. The method of claim 15, wherein said central management system comprises a software application installed on a server connected on the user intranet.

18. A computer-implemented method for managing a network of electronic devices connected on a network, each of the electronic devices including firmware stored on device memory, the method comprising:
maintaining a central management system configured to control firmware update, firmware rollback and device cloning activities for said electronic devices;
maintaining a local electronic memory accessible by the central management system for storing firmware images of current firmware in use by one or more of the electronic devices, and configuration settings for one or more of the devices;
using the central management system to initiate a firmware update activity for a selected one of said electronic devices;
accessing the central management system to initiate a firmware rollback activity for a selected one of said electronic devices; and
accessing the central management system to initiate a cloning activity.

19. The method of claim 18, wherein said initiating said firmware update activity includes:
storing an image of the current firmware and a current set of said configuration settings for said selected device in said local electronic memory;
conducting a firmware update activity for said selected electronic device.

20. The method of claim 18, wherein said initiating a firmware rollback activity includes:
retrieving an image of a prior version of a firmware utilized by said selected one of said electronic devices, and installing said image on said selected one of said electronic devices.

21. The method of claim 18, wherein said initiating said cloning activity includes:
retrieving an image of a firmware in use by a source electronic device;
installing said retrieved image on a target electronic device;
retrieving a set of configuration settings from said source electronic device and installing said set on said target electronic device.

22. The method of claim 18, wherein said initiating said cloning activity includes:
detecting a presence of a new electronic device on the network;
fetching a profile including a profile firmware image and a set of configuration settings for a device family corresponding to the new electronic device;
initiating a firmware update for said new electronic device using said profile firmware image;
initiating copying said set of configuration settings to said new electronic device.

23. A computer-implemented method for managing a network of electronic devices connected on a computer network, each of the electronic devices including firmware stored on device memory, the method comprising:
maintaining a central management system configured to control device cloning activities for said electronic devices;
maintaining a local electronic memory accessible by the central management system for storing firmware images and configuration settings for one or more of the devices;
accessing the central management system to initiate a cloning activity;
retrieving a firmware image from said local electronic memory;
installing said retrieved firmware image on a target electronic device connected on the network;
retrieving a set of configuration settings from the local electronic memory and copying said set on the target electronic device.

24. The method of claim 23, wherein said retrieving said firmware image comprises:
using the central management system to acquire details of the target device firmware;
using said acquired details, searching said local memory for said firmware image.

25. The method of claim 24, further comprising:
generating a message that the cloning process cannot be completed if the local memory does not have an image of the target device firmware.

26. The method of claim 23, wherein said target electronic device is newly installed on the network, said method further comprising:
detecting the presence of the target electronic device; and
determining a family of devices to which said target electronic device belongs; and
wherein said retrieving a firmware image from said local electronic memory comprises retrieving a stored profile firmware image corresponding to said family of devices.

27. A computer-implemented method for managing a network of electronic devices connected on a computer network, each of the electronic devices including firmware stored on device memory, the method comprising:
maintaining a central management system configured to control device cloning activities for said electronic devices, wherein firmware and configuration settings of a source electronic device connected on the network are installed on a target electronic device connected on the network;
maintaining a local electronic memory accessible by the central management system for storing firmware images of current firmware in use by one or more of the electronic devices, and configuration settings for one or more of the devices;
accessing the central management system to initiate a cloning activity;
retrieving an image of a firmware in use by the source electronic device;
installing said retrieved image on the target electronic device;
retrieving a set of configuration settings from the source electronic device and installing said set on the target electronic device.

28. The method of claim 27, wherein said retrieving said image of a firmware comprises:
using the central management system to acquire details of the target device firmware;
using said acquired details, searching said local memory for said image.

29. The method of claim 28, further comprising:
generating a message that the cloning process cannot be completed if the local memory does not have an image of the target device firmware.
